(19) United States
(12) Patent Application Publication
(10) Pub. No.: US 2010/0237264 A1
(43) Pub. Date: Sep. 23, 2010

(54) Valve operating mechanism

(76) Inventors: Markus Lengfeld, Winnenden (DE); Jens Meintschel, Bernsdorf (DE); Thomas Stolk, Kirchheim (DE); Alexander Von Gaisberg-Helfenberg, Beilstein (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/799,787

(22) Filed: Apr. 30, 2010

Related U.S. Application Data
(63) Continuation-in-part of application No. PCT/EP2008/008693, filed on Oct. 15, 2008.

(30) Foreign Application Priority Data
Nov. 2, 2007 (DE) 10 2007 052 253.5

(51) Int. Cl. F16K 35/00

(52) U.S. Cl. 251/89

(57) ABSTRACT

In a valve operating mechanism of an internal combustion engine, with an actuation device including at least two shifting elements which are driven by actuators for engaging a shifting gate of a cam control element, a safety device is provided to prevent the shifting elements from being deployed simultaneously.

This is a Continuation-in-Part Application of pending international patent application PCT/EP2008/008693 filed Oct. 15, 2008 and claiming the priority of German patent application 10 2007 052 253.2 filed Nov. 2, 2007.

### BACKGROUND OF THE INVENTION

The invention relates to a valve operating device, in particular of an internal combustion engine with an actuating device including at least two shifting elements provided for engaging a guide structure for shifting the cams of a camshaft actuating the valves.

Valve operating mechanism of an internal combustion engine with an actuation device which has at least two shifting elements driven via actuators which are provided to engage in a shifting gate of a cam element are already known.

It is the principal object of the invention to provide a valve operating device, in which the chances of damage by a malfunctions are reduced.

### SUMMARY OF THE INVENTION

In a valve operating mechanism of an internal combustion engine, with an actuation device including at least two shifting elements which are operated via actuators engaging a shifting gate of a cam control element, a safety device is provided to prevent the shifting elements from being deployed simultaneously in order to prevent a lock-up of the operating mechanism.

The safety device is a mechanical device by which for example pressure forces or friction forces, are used for blocking the shifting elements. The arrangement provides a particularly simple design of a mechanical safety device.

The safety device includes an actuator, which is designed as an at least partially integral part of an actuator of the shifting device. The adjusting force for adjusting the shifting elements can thereby be used for a shifting of the safety device.

Preferably, the safety device has a blocking pin, whereby the safety device can be operated in a particularly safe manner.

A recess is preferably provided in at least one shifting element. A mechanical counter element to the blocking pin can thereby be created in a simple manner, into which the blocking pin engages and thus blocks the actuation device.

In a further embodiment of the invention, the safety device is an electrical and/or magnetic device. An “electrically and/or mechanical safety device” is a safety device, in which forces are used for blocking the shifting elements, which act via electrical, electromagnetic and/or magnetic fields. A shiftable safety device can thereby be realized in a particularly simple manner.

The safety device has preferably at least two electrical solenoids, which are provided to generate a magnetic field. A blocking force for blocking an actuation element can thereby be created in a simple manner.

Preferably, the safety device has at least one electrical safety unit, which connects the two solenoids to one another. A polarity of the one solenoid thereby has a defined direction with regard to a polarity of the other solenoid, whereby a defined interaction with a corresponding component can be achieved in a simple manner, as for example with the use of a permanent magnet. The solenoids may be advantageously connected in parallel or in series, whereby a polarity in the same direction or a polarity in the opposite direction can be achieved in a simple manner. The circuit can advantageously also be optimized by means of electrical components, as for example diodes.

Preferably, the actuation device and the safety device are formed at least partially as a single piece. The safety device can thereby be provided in a particularly compact manner.

The invention will become more readily apparent from the following description of particular embodiments thereof with reference to the accompanying drawings.

### BRIEF DESCRIPTION OF THE DRAWINGS

FIG. 1 is a perspective of an actuation device with a mechanical safety device,

FIG. 2 is a sectional view of the safety device with a deployed actuation plunger,

FIG. 3 shows an actuation device with an electrical safety device,

FIG. 4 shows an electrical safety circuit of the safety device of FIG. 3,

FIG. 5 shows an alternative arrangement of an electrical safety circuit,

FIG. 6 shows a further arrangement of an electrical safety device,

FIG. 7 shows a further actuation device with an electrical safety device,

FIG. 8 shows an arrangement of a safety circuit of the electrical safety device of FIG. 7,

FIG. 9 shows an alternative arrangement of an electrical safety circuit, and

FIG. 10 shows a further arrangement of an electrical safety circuit.

### DETAILED DESCRIPTION OF PARTICULAR EMBODIMENTS

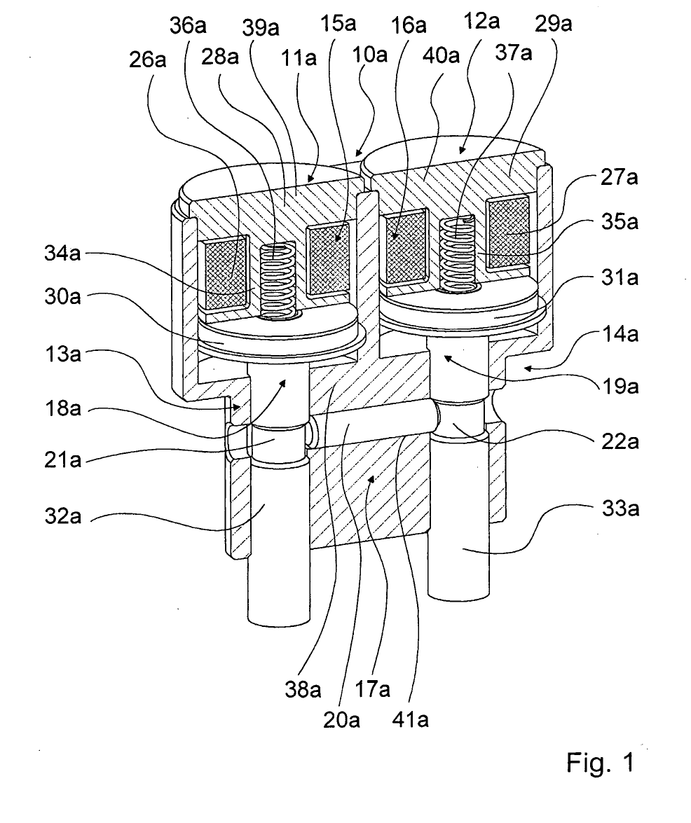

FIG. 1 shows a valve operating device with an actuation device 10a. The actuation device 10a has two shifting elements 13a, 14a, which are moved via actuators 11a, 12a. The shifting elements 13a, 14a are provided to engage in a shifting gate with gate paths of a cam element, not shown in detail, so as to displace the cam element axially on a cam shaft, not shown in detail.

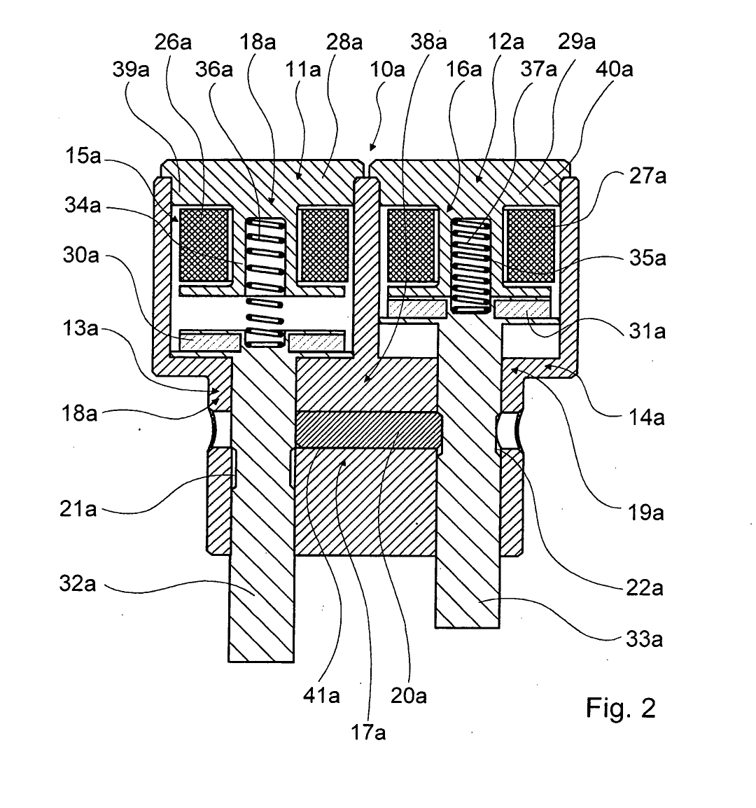

The first actuator 11a, which moves the first shifting element 13a, has an electromagnetic unit 15a. The electromagnetic unit 15a comprises a solenoid 26a, which is arranged in a stator 28a of the electromagnetic unit 15a. A magnetic field can be generated by means of the solenoid 26a, which field interacts with a permanent magnet 30a, which is arranged in the shifting element 13a. The shifting element 13a, which has an actuating plunger 32a, can thereby be deployed (FIG. 2). A core 34 reinforces the magnetic field generated by the electromagnetic unit 15a.

When the solenoid 26a is deenergized, the permanent magnet 30 interacts in a first end position with a basic housing part 38a of the actuator 11a, which consists of a magnetizable material, and, in a second end position, with the stator 28a of the actuator 11a. In such an operating state, the permanent magnet 30a stabilizes the shifting element 13a in one of the two end positions, wherein the shifting element 13a tends to move from a position between the end positions toward the energetically more favorable end position.

In an operating state, in which the electromagnetic unit 15a is energized, the permanent magnet 30a interacts with the field of the electromagnetic unit 15a. Depending on a polarization of the permanent magnet 30a and the electromagnetic unit 15a, an attracting force and a repelling force can be realized thereby. A polarization of the electromagnetic unit 15a can be changed by changing the direction of the current by which the electromagnetic unit 15a is energized.

A spring unit 36a is further arranged in the actuator 11a, which also exerts a force on the shifting element 13a. The force of the spring unit 36a is directed in a direction which corresponds to a direction of the repelling force between the electromagnetic unit 15a and the permanent magnet 30a, whereby a deployment process of the shifting element 13a can be accelerated.

The second actuator 12a is constructed in an analogous manner to the first actuator 11a. It comprises an electromagnetic unit 16a, which has a solenoid 27a arranged in a stator 29a with a magnetizable core 35a, which interacts with a permanent magnet 31a arranged in the shifting element 14a and can deploy an actuation plunger 33a. A deployment process of the actuator 12a is also accelerated by a spring unit 37a.

The two actuators 11a, 12a are arranged in a common basic housing part 38a. The solenoids 26a, 27a of the actuators 11a, 12a are wound around housing parts 39a, 40a which can be assigned individually to the actuators, and which are designed in one piece with the cores 34a, 35a of the electromagnetic units 15a, 16a.

In order to prevent a simultaneous deployment of the two shifting elements 13a, 14a, the valve operating device has a safety arrangement 17a. The safety arrangement 17a is designed in a mechanical manner and has a blocking pin 20a. The blocking pin 20a is arranged between the actuation plungers 32a, 33a of the shifting elements 13a, 14a. It is movable in an axial direction with regard to the blocking pin 20a and is supported in a passage 41a in the basic housing part 38a.

The actuation plungers 32a, 33a of the shifting elements each have a respective recess 21a, 22a, into which the blocking pin can enter. The recesses 21a, 22a are here formed as circumferential groove and have a chamfer towards the edge. If one of the actuation plunger 32a, 33a is deployed, the blocking pin 20a is moved completely into the recess 22a, 21a of the other actuation plunger 33a, 32a because of the chamfer of the recess 21a, 22a and a corresponding chamfer at the deploying actuation plunger 32a, 33a, whereby the other activation plunger is blocked against a deployment. If the actuation plunger is retracted again, the other actuation plunger 33a, 32a can be deployed and thereby moves the blocking pin 20a into the recess of the first actuation plunger 32a, 33a, whereby the first actuation plunger is blocked. The blocking pin 20a is moved by the actuation plunger 32a, 33a. Actuators 18a, 19a, by means of which the blocking pin is displaced axially and which move the shifting elements 13a, 14a, are integral parts of the actuators 11a, 12a of the actuation unit.

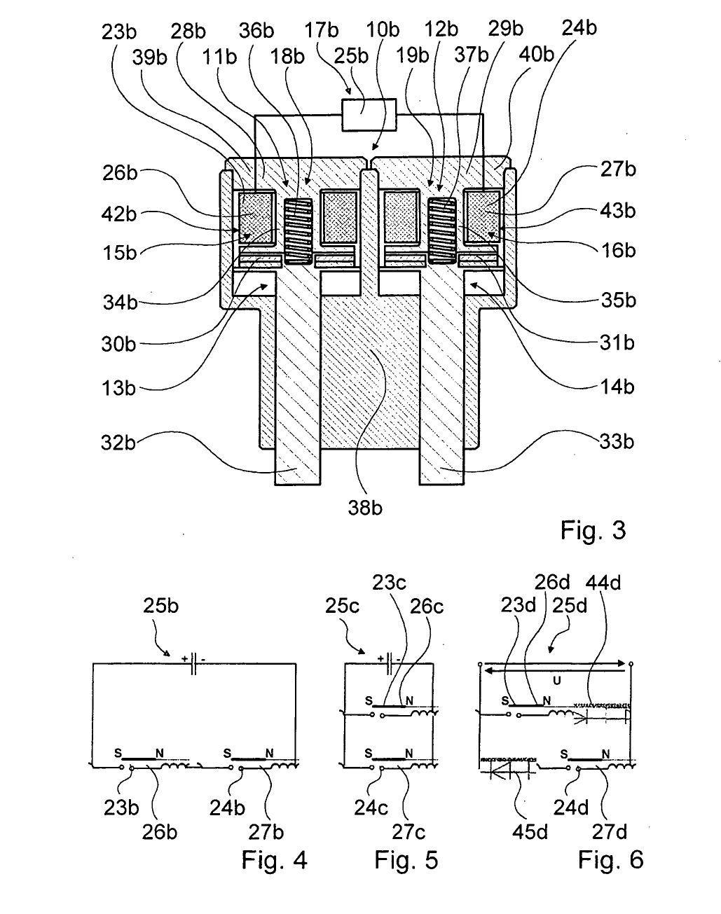

FIG. 3 shows an alternative embodiment of a valve actuation device, which has an actuation device 10b with two actuators 11b, 12b and an electrical safety device 17b. For distinguishing the embodiments, the letter a in the reference numerals of the embodiment in FIGS. 1 and 2 is replaced by the letters b to g in the reference numerals of the embodiments of FIGS. 3 to 10. The following description is essentially restricted to the differences to the embodiment in FIGS. 1 and 2, wherein one can refer to the description of FIGS. 1 and 2 with regard to the same components, characteristics and functions.

The safety device 17b, which is shown in FIG. 3, has an electrical safety circuit 25b, by means of which two solenoids 23b, 24b of the safety device 17b are connected to each other. The solenoids 23b, 24b form electromagnetic units 42b, 43b of the safety device 17b, which serve as actuators 18b, 19b of the safety device 17b for blocking shifting elements 13b, 14b of the actuation device 10b. The actuators 18b, 19b are designed in one piece with the actuators 11b, 12b of the actuation device 10b, wherein in particular solenoids 26b, 27b and electromagnetic units 15b, 16b of the actuation device are designed in one piece with those of the safety device 17b.

The electrical solenoids 23b, 26b, 24b, 27b, which are respectively designed in pairs in one piece for the safety device 17b and the actuation device 10b are energized in the same way by means of the electrical safety circuit 25b (FIG. 4). The solenoids 23b, 26b, 24b, 27b are thereby connected in series. An identical polarization of the two solenoids 23b, 26b, 24b, 27b is obtained by the same energization. Permanent magnets 30b, 31b, which are arranged in the shifting elements 13b, 14b, have an opposite polarity. The permanent magnet 30b of the first actuator 18b, 11b, which is designed in one piece for the safety device 17b and the actuation device 10b, has a North pole at a side facing the electromagnetic unit 42b, 15b. The permanent magnet 31b of the second actuator 19b, 12b has a South pole at a side facing the electromagnetic unit 43b, 16b. The arrangement can also be changed around in principle. If the solenoids 23b, 26b are supplied with current in a first direction, a force acts on the shifting element 13b of the first actuator 18b, 11b in the direction of the electromagnetic unit 42b, 15b, while a repelling force acts on the shifting element 14b of the second actuator 19b, 12b. The second shifting element 14b is thereby deployed, while the first shifting element 13b is blocked. If a direction of the electrical current is reversed, the first shifting element 13b is deployed and the second shifting element 14b is blocked.

FIG. 5 shows an alternative arrangement of an electrical safety circuit 25c for a safety device 17c with permanent magnets 30c, 31c with opposite polarity. With this circuit, two solenoids 23c, 26c, 24c, 27c, which are designed in pairs in one piece for the safety device 17c and an actuation device 10c, are connected in parallel.

A further arrangement of an electrical safety circuit 25d for a safety device 17d with permanent magnets 30d, 31d having different polarity is shown in FIG. 6. With this safety circuit 25d, the solenoids 23d, 26d 24d, 27d, which are designed in one piece in pairs, are also connected in parallel. Diodes 44d, 45d are connected in series with the solenoids 23d, 26d, 24d, 27d, whereby only one of the of the solenoids 23d, 26d, 24d, 27d, which are designed in one piece in pairs, is supplied with current. With the help of a condition circuit, which is not shown in detail here, it can be ensured with all arrangement versions that shifting elements 13d, 14d are deployed in an alternative manner.

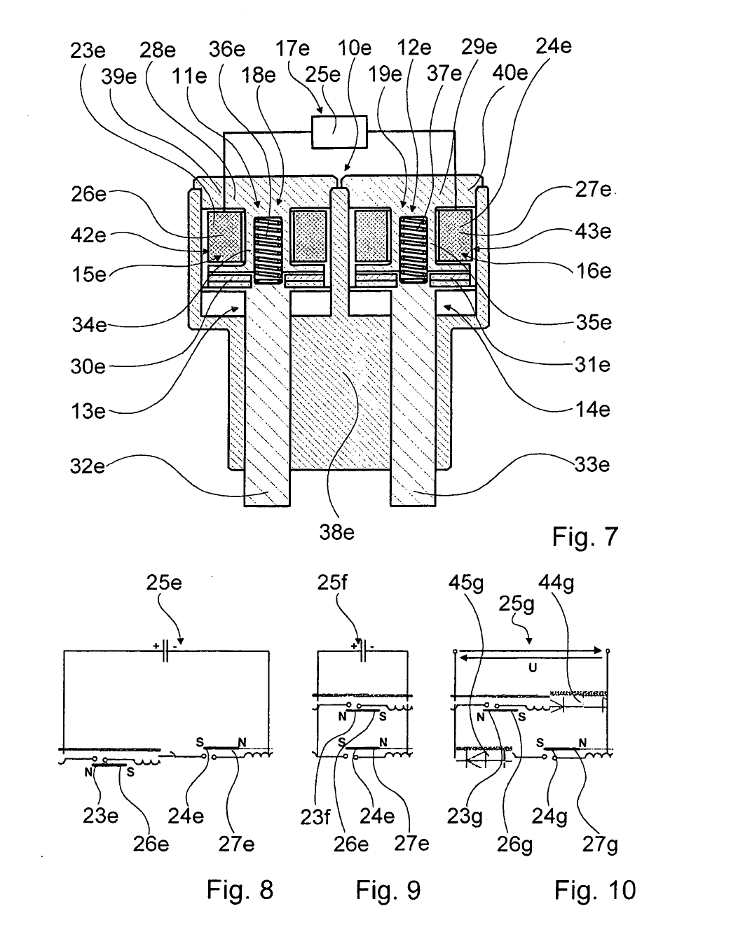

FIG. 7 shows a further embodiment of a valve operating device with an actuation device 10e and an electrical safety device 17e. In contrast to the embodiment in FIG. 3, the permanent magnets 30e, 31e in the shifting elements 13e, 14d have the same polarization. One of two electrical solenoids 23e, 26e, 24e 27e, which are designed in pairs in one piece for the safety device 17d and the actuation device 10d, has a changed winding, whereby the two solenoids 23e, 26e, 24e, 27e generate oppositely directed fields (FIG. 8). Thereby, one of the shifting elements 13e, 14e is deployed with the same current feed of the solenoids 23e, 26e, 24e, 27e, while the other shifting element 14e, 13e is blocked. The solenoids 23e, 26e, 24e, 27e are thereby connected in series by means of an electrical safety circuit 25e.

FIG. 9 shows an alternative arrangement of an electrical safety circuit 25f for a safety device 27f with permanent magnets 30f, 31f having the same polarity. With this safety circuit 25f, two solenoids 23g, 26g, 24g, 27g which are designed in pairs in one piece, are connected in parallel.

A further arrangement of an electrical safety circuit 25g for a safety device 17g with permanent magnets 30g, 31g having the same polarity is shown in FIG. 10. With this safety circuit 25g, the solenoids 23g, 26g 24g, 27g, which are designed in one piece in pairs, are also connected in parallel. Diodes 44g, 45g are connected in series with the solenoids 23g, 26g, 24g, 27g, whereby only one of the of the two solenoids 23g, 26g, 24g, 27g is supplied with current depending on the current direction. With the help of a condition circuit, which is not shown in detail here, it can be ensured with all arrangement versions that shifting elements 13g, 14g are deployed alternatively.

What is claimed is:

1. A valve operating mechanism for an internal combustion engine, with an actuation device (10a-g) which has at least two shifting elements (13a-g, 14a-g) and actuators (11a-g, 12a-g) for engaging in a shifting gate of a cam element, and a safety device (17a-g) for preventing a simultaneous deployment of both shifting elements (13a-g, 14a-g).

2. The valve operating device according to claim 1, wherein the safety device has at least one actuator (18ag, 19a-g), which is formed at least partially integrally with an actuator (11a-g, 12a-g) of the actuation device (10a-g).

3. The valve operating device according to claim 1, wherein the safety device is a mechanical device.

4. The valve operating device according to claim 1, wherein the safety device (17a) includes a blocking pin (20a) permitting deployment of only one of the shifting elements (13a-g, 14a-g) at a time.

5. The valve operating device according to claim 1, wherein a recess (21a, 22a) is formed in at least one shifting element (13a, 14a).

6. The valve operating device according to claim 1, wherein the safety device (17b-g) is in the form of one of an electrical and magnetic device.

7. The valve operating device according to claim 1, wherein the safety device (17b-g) has at least two electrical solenoids (23b-g, 24b-g), which are provided to generate a magnetic field.

8. The valve operating device according to claim 7, wherein the safety device (17b-g) has an electrical safety switch (25b-g), which connects the two solenoids (23b-g, 24b-g) to each other.

9. The valve operating device according to claim 1, wherein the actuation device (10a-g) and the safety device (17a-g) are formed at least partially in one piece.
